(19) United States
(12) Patent Application Publication
(10) Pub. No.: US 2007/0011862 A1
(43) Pub. Date: Jan. 18, 2007

(54) Lighting element comprising an inserted light-guiding body

(76) Inventor: Jens Mertens, Esslingen (DE)

Correspondence Address: CLARK HILL, P.C., 500 WOODWARD AVENUE, SUITE 3500, DETROIT, MI, 48226, US

(21) Appl. No.: 10/574,376

(22) PCT Filed: Oct. 4, 2004
(86) PCT No.: PCT/DE04/02212

§ 371 Date: Apr. 3, 2006

(30) Foreign Application Priority Data
Oct. 3, 2003 (DE) 10346452.2

(51) Int. Cl. H01S 4/00

(52) U.S. Cl. 29/592.1

(57) ABSTRACT

A method produces a lighting element that includes at least one luminescent diode and an inserted light-guiding body. The light-guiding body receives light emitted by the luminescent diode. The luminescent diodes are secured to the light-guiding body by an injection molding process of a transparent plastic material such that at least 50% of the surface of the light emitting diode is covered by the injected material during the manufacturing thereof, and that the maximum wall thickness of the injected layer does not exceed three-times the minimum wall-thickness of the layer.

### BACKGROUND ART

1. Field of the Invention

The invention relates to a method for the production of a lighting element including at least one luminescent light source and an inserted light-guiding body. More particularly, the invention relates to a lighting element of uniform construction and a method of making same.

2. Description of the Related Art

Such a method for the production of a lighting element is known from the German patent specification DE 101 63 117. Here, a first LED-partial body is permanently connected to a second, larger light-guiding body by injection molding. However, a special component is used here as the LED-partial body. This solution also results in portions of large material build-ups in the injection mold. This requires inter alia a longer cooling-off time and brings about an uneven cooling.

Therefore the problem underlying the present invention is to develop a method for the production of light-guiding lighting elements by using at least one inserted light-guiding body, wherein the transparent partial illuminating bodies are connected to one another in a safe, rapid and precise manner with respect to the form thereof with the usual capacity of the known injection methods.

### SUMMARY OF THE INVENTION

A method produces a lighting element that includes at least one luminescent diode and an inserted light-guiding body. The light-guiding body receives light emitted by the luminescent diode. The luminescent diodes are secured to the light-guiding body by an injection molding process of a transparent plastic material such that at least 50% of the surface of the light emitting diode is covered by the injected material during the manufacturing thereof, and that the maximum wall thickness of the injected layer does not exceed three-times the minimum wall-thickness of the layer.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a cross-sectional end view of one embodiment of the invention; and

FIG. 2 is a cross-sectional side view of the embodiment shown in FIG. 1.

### DETAILED DESCRIPTION OF THE PREFERRED EMBODIMENTS

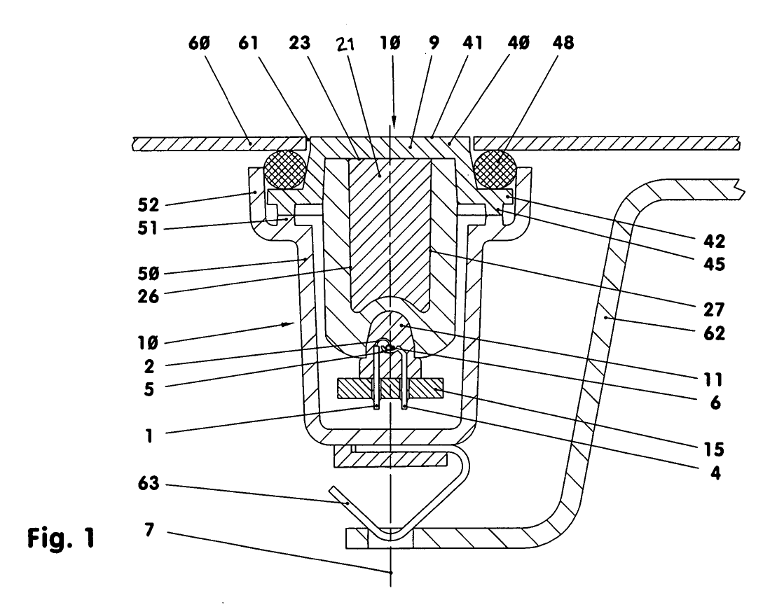

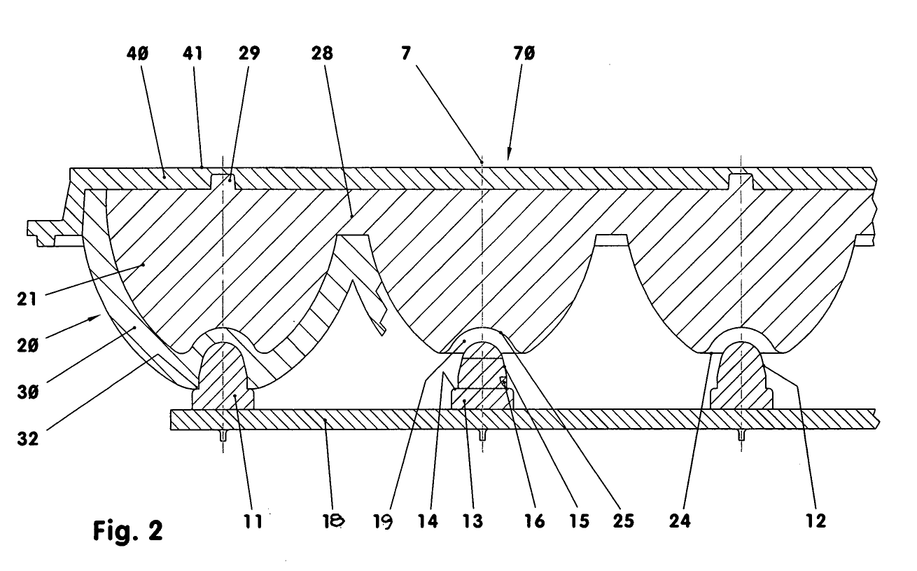

FIGS. 1 and 2 show a lighting element 70. In the embodiment shown, the lighting element 70 is a raised automobile brake light. The lighting element 70, which is arranged here, for example, with the help of a housing 50 in a trunk lid 60 of a motor vehicle, is made of a group of individual lighting elements 10, wherein every element 10 includes at least one light source 11. In the preferred embodiment, the light source 11 is a light emitting diode (LED). The lighting element 70 has a diffusing screen 40, the outer surface of which is adapted to the shape of the surrounding surface curvature of the trunk lid 60.

In this context, the individual LED 11 can be a standard LED or a preliminary stage LED. The latter is produced only for installation in the brake light 70. The LED 11 usually includes the electrical terminals 1, 4 located in one plane, the light-emitting chip 6, a bond wire 2, and a reflector dish 5. The latter is a part of the cathode 4. The chip 6 is seated in the reflector dish 5. The chip 6 contacts the anode 1 using the bond wire 2. The bond wire 2 is thereby preferably located in the plane, which is defined by the centerlines of the electrodes 1, 4. The zone located above the chip 6 transports the light emitted by the chip 6 losslessly, as far as possible, to the outer surface 12 of the LED 11.

The standard LED used in FIG. 1 has a geometric form, which is substantially made of three geometric bodies arranged on top of one another. The first geometric body is a short, at least approximately straight cylinder 13, which includes, if desired, two planar flat portions, which are aligned generally parallel to the LED centerline 7. The second geometric body is a truncated cone 15 arranged on the upper end face 14 of the cylinder 13 or a comparable rotational body, which tapers away from the cylinder 13. The third geometric body is a calotte and/or a comparable rotationally symmetrical cap, which is positioned on the upper, smaller end face of the truncated cone. The surface line of the truncated cone thereby passes tangentially into the contour of the cap. The upper end face 14 of the cylinder 13 is larger than the lower end face of the truncated cone 15. The centerlines of the cylinder 13 and of the truncated cone 15 are located on the LED centerline 7.

If desired, a notch 16, a channel or a waist, shown as a dashed line in FIG. 2, which ends on the end face 14, is present in the lower regions of the truncated cone 15.

Should the individual lighting element 10 be used in a group of several individual lighting elements, the LEDs 11 are arranged on a lamellar circuit board 18. For this purpose, the LEDs 11 are soldered permanently on the circuit board 18 after being previously glued thereon. The circuit board 18 connects the individual LEDs 11 using superimposed conductor tracks. If desired, every other electronic component, such as multipliers, blocking diodes or integrated circuits, are arranged on the circuit board 18 in known manners. The circuit board 18 positions the LEDs 11 in relation to one another and later—during the coating—in the injection molding device. If desired, the electrodes 1, 4 of the LEDs 11 are also discretely connected electrically using individual cables.

In the embodiment shown, the inserted light-guiding body 21 located opposite to the respective LED 11 has the shape of a partial paraboloid, which is flattened on both sides and also truncated at the top and at the bottom. The flattened lateral surfaces 26, 27 are located approximately parallel to a midplane, which is located according to FIG. 1 on the centerline 7 of the respective individual lighting element 10. The minimum distance of the lateral surfaces 26, 27 from the midplane amounts, e.g. to 50% of the maximum LED diameter or the maximum LED width. In the example embodiment, the distance between the lateral surfaces 26, 27 is larger towards the main light exit surface 41.

A spherical concave recess 25 is present in the end face 24 of the lower truncation according to FIG. 2. In this context, the recess 25 is curved in such a way that the gap 19 lying between the recess 25 and the LED 11 has an at substantially constant width.

The other end face 23 is a top face, planar and oriented normal to the centerline 7 of the individual lighting element 10. If desired, a short pin 29, cf. FIG. 2, is molded in the middle region, e.g. centrally, wherein the short pin 29 facilitates the handling and positioning when coating by means of injection molding. The length of the pin 29—measured in the longitudinal extension along the centerline 7—is shorter than the thickness of the diffusing screen 40 in the vicinity of the pin. A transparent, colorless plastic is provided as the material for the diffusing screen.

Should several individual lighting elements 10 be combined in a group 70 and should these lighting elements 10 be located adjoining one another, each would be connected to one another using at least one web 28. In this context, each web 28 has a semi-circular cross-section. The webs 28 adjoin flush to the end faces 23 wherein they form a planar or curved surface with the latter.

For the purpose of coating by means of injection molding, the circuit board 18 is inserted with the LEDs 11 and the group consisting of inserted light-guiding bodies 21 into an injection mold. In this context, the distance of individual LED 11 from the inserted light-guiding body 21 at the narrowest place amounts to between 0.3 mm and 3 mm. The injection mold is designed in such a way that the finished injected layer for each pair of LED and inserted light-guiding body in turn forms a partial paraboloid 30, which is flattened on both sides and truncated at least at the top. The lower edge of this partial paraboloid rests against the LED 11 below a plane, which extends through the center of gravity of the LED chip 6 and, secondly, is aligned normal to the centerline 7. In the example embodiment, the lower edge 32 of the injected layer 30 rests against the end face 14 of the cylinder 13 of the LED 11. For example, the edge 32 is located directly in the geometrical cut edge, which is formed by the penetration of the cylinder 13 and of the rotational body and/or of the truncated cone 15.

The surface of the partial paraboloid 30 is located at a distance from the surface of the partial paraboloid of the inserted light-guiding body 21, said distance corresponding to e.g. two-times the width of the gap 19. The injected layer 30 has an almost constant wall-thickness over large regions. In zones of strong curvature, the wall-thickness can increase up to three-times the width of the gap. These small differences in the wall-thickness enable a production of the individual lighting element 10 without any problems.

The injected layer 30 positively engages behind the corresponding LED in case of LEDs having a notch 16. The inserted light-guiding bodies 21 can also have notches, channels or annular grooves of the same function. The injected layer 30 may be a colorless, transparent plastic is used for the coating by means of injection molding. FIG. 2 illustrates the injected layer 30 only in case of the first inserted light-guiding body 21.

In another step, the diffusing screen 40 is sprayed onto the end surfaces 23 of the inserted light-guiding body 21. In this context, the diffusing screen 40 engages around the injected layer 30, in the upper fifth part. The diffusing screen 40 accordingly covers the inserted light-guiding body 21 on the end face 23 and the injected layer 30 on the upper edge completely. It has a flange-shaped installation edge 42, which is parallelly displaced in relation to its main light exit surface 41 and which surrounds the entire brake light 70. The main light exit surface 41 is designed with a smooth or structured surface. For example, a red, transparent thermoplastic is used as the material.

The light-guiding and current-carrying components 11, 21, 30, 18 of the middle, raised brake light 70 are surrounded by the housing 50 on the rear side as shown in FIG. 1. The housing 50 made from a hard substance, e.g., a metal, is a dish which can be closed with a lid. In this context, the lid is a diffusing screen 40 seated tightly on the dish. For this purpose, sealing contours 45, 51 contacting one another flatly are embodied on the diffusing screen 40 and on the housing 50. For the protection of these sealing contours 45, 51 and for holding a sealing ring 48, the housing 50 is partially guided around the diffusing screen 40 as a supporting edge as shown in FIG. 1.

The brake light 70 is installed in the trunk lid, in the tailgate or on the rear roof edge in such a way that the surface of the diffusing screen 40 adjoins tangentially to the surface of the autobody sheet steel 60 carrying the brake light 70. In this context, the autobody sheet steel 60 can also be manufactured from a non-metallic material. The diffusing screen 40 is inserted from the rear side together with the housing 50 into a recess 61 and is clamped there by means of a leaf spring 63 (with a two-fold curvature here) against a mounting bracket 62, which is stationary in relation to the autobody sheet steel 60. In the installed state, the recess 61 is sealed by the diffusing screen 40 and the sealing ring 48 resting on the flange-type edge 42 of the diffusing screen 40 against the intrusion of water and dirt.

In order to create the typical appearance of a middle brake light, the colors of the individual components 11, 21, 30, 40 can be used in different variations.

Certain substances, which change the wavelength of the light emitted from the chip 6 can be combined with the materials of the individual transparent components of the brake light 70, as a result of which the subjectively recognizable luminous color corresponds to that of a typical brake light 70, although the material of the unlighted brake light has another color, e.g. the color of the surrounding autobody sheet steel 60.

An individual lighting element 10 can naturally also be used separately.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A method for the production of a lighting element comprising at least one luminescent diode and an inserted light-guiding body, which is arranged in front of said luminescent diode in the direction of the exit of the main light, wherein the respective luminescent diodes are connected to the inserted light-guiding body by an injection molding process with transparent plastic, the method comprising:
at least 50% of the surface of the light-emitting diodes is covered by the transparent plastic during injection molding, and
that the maximum wall thickness of the transparent plastic does not exceed three-times the minimum wall-thickness of the transparent plastic.

2. A method according to claim 1, characterized in that the lower edge of the transparent plastic engaging radially around the surface of the light-emitting diode ends below a plane, which runs normal to the centerline of the luminescent diode and through the center of gravity of the light-emitting chip of this luminescent diode.

3. A method according to claim 1, characterized in that the luminescent diode and the inserted light-guiding body are located on a common centerline, wherein the centerline runs through the center of gravity of the light-emitting chip of the luminescent diode.

4. A method according to claim 1, characterized in that the lighting element is made of several individual lighting elements arranged adjoining to one another.

5. A method according to claim 4, characterized in that the centerlines of the individual lighting elements are arranged parallel to one another or intersect in an at least partially fan-like manner at one or more points located behind the lighting element or intersect at a short distance.

6. A method according to claim 1, characterized in that the inserted light-guiding body includes a concave recess towards the diode.

7. A method according to claim 1, characterized in that a light lens for designing a main light exit surface is molded into the combination of the diode, the inserted light-guiding body and the injected layer in an additional injection molding step.

8. A method according to claim 7, characterized in that the light lens is a diffusing screen.

9. A method according to claim 8, characterized in that the inserted light-guiding body has a different color than that of the diffusing screen.

10. A method according to claim 1, characterized in that at least one substance is admixed to the material of at least one component, wherein said substance emits a light of another wavelength when excited by the light emitted from the chip.

11. A method according to claim 1, characterized in that the luminescent diodes are fixed on a circuit board before the coating by injection molding.

12. A lighting element comprising:
a light source for emitting light;
a light-guiding body spaced from said light source for receiving the emitted light and for focusing the emitted light to create focused light; and
a layer of plastic disposed between said light source and said light-guiding body to position said light source relative to said light-guiding body, said layer of plastic covering at least fifty percent of said light source.

13. A lighting element as set forth in claim 12 wherein said layer of plastic defines a wall thickness having a maximum wall thickness and a minimum wall thickness.

14. A lighting element as set forth in claim 13 wherein said maximum wall thickness is less than three times said minimum wall thickness.

15. A lighting element as set forth in claim 14 wherein said layer of plastic includes a lower edge disposed about and engaging said light source.

16. A lighting element as set forth in claim 15 wherein said light source and said light-guiding body are coaxial.

17. A lighting element as set forth in claim 16 wherein said light source is, a light emitting diode.

18. A lighting element as set forth in claim 17 wherein said light emitting diode and said light-guiding body are coaxial.

19. A lighting element as set forth in claim 18 wherein said light-guiding body includes a concave recess disposed adjacent to and coaxial with said light emitting diode.

20. A lighting element as set forth in claim 19 including a light lens for diffusing said focused light.

21. A lighting element as set forth in claim 20 wherein said light lens includes diffusing screen.

22. A lighting element as set forth in claim 21 wherein said light-guiding body defines a first color and said diffusing screen defines a second color such that said first color differs from said second color.

23. A lighting element as set forth in claim 22 including an integrated circuit board wherein said light emitting diode is secured thereto.

24. A lighting element as set forth in claim 23 wherein said light-guiding body includes flattened lateral surfaces.
